(19) United States
(12) Patent Application Publication
(10) Pub. No.: US 2019/0094928 A1
(43) Pub. Date: Mar. 28, 2019

(54) INFORMATION PROCESSING APPARATUS

(71) Applicant: FUJITSU LIMITED, Kawasaki-shi (JP)

(72) Inventors: Keita Hirai, Kawasaki (JP); Tsuyoshi So, Kawasaki (JP); NAOFUMI KOSUGI, Yokohama (JP)

(73) Assignee: FUJITSU LIMITED, Kawasaki-shi (JP)

(21) Appl. No.: 16/130,149

(22) Filed: Sep. 13, 2018

(30) Foreign Application Priority Data
Sep. 25, 2017 (JP) 2017-183960

(51) Int. Cl. G06F 1/20; F28D 15/02

(52) U.S. Cl. CPC G06F 1/206; G06F 2200/201; F28D 15/0275; F28D 15/0266

(57) ABSTRACT

An information processing apparatus includes a plurality of processors, a manifold that collects refrigerant liquid discharged from the plurality of processors, a first pipe that is coupled to the manifold and discharges the refrigerant liquid collected in the manifold, a throttle portion that is disposed in the first pipe and forms a throttle hole penetrating in an axis direction of the first pipe inside the first pipe, and a narrow tube that extends from an inside upper portion of the manifold to inside of the first pipe and is inserted into the throttle hole.

### CROSS-REFERENCE TO RELATED APPLICATION

This application is based upon and claims the benefit of priority of the prior Japanese Patent Application No. 2017-183960, filed on Sep. 25, 2017, the entire contents of which are incorporated herein by reference.

### FIELD

The embodiments discussed herein are related to an information processing apparatus.

### BACKGROUND

As a cooling apparatus that cools a plurality of information processing units mounted in an information processing apparatus, for example, there is a water cooling-type cooling apparatus that cools a plurality of information processing units by supplying refrigerant liquid to the plurality of information processing units.

In such a water cooling-type cooling apparatus, if air is mixed or left in a refrigerant liquid flow path through which the refrigerant liquid flows, there is a risk that the flow of the refrigerant liquid is obstructed. When the flow of the refrigerant liquid is obstructed in this way, flow rate differences of the refrigerant liquid supplied to the plurality of information processing units increase, so that there is a risk that an information processing unit that may not obtain a desired flow rate is not cooled sufficiently.

The followings are reference documents.

### [Document 1] Japanese Laid-open Patent Publication No. 2012-181714,

[Document 2] International Publication Pamphlet No. WO 2012/059975, and

### [Document 3] Japanese Laid-open Patent Publication No. 2010-79402.

### SUMMARY

According to an aspect of the invention, an information processing apparatus includes a plurality of processors, a manifold that collects refrigerant liquid discharged from the plurality of processors, a first pipe that is coupled to the manifold and discharges the refrigerant liquid collected in the manifold, a throttle portion that is disposed in the first pipe and forms a throttle hole penetrating in an axis direction of the first pipe inside the first pipe, and a narrow tube that extends from an inside upper portion of the manifold to inside of the first pipe and is inserted into the throttle hole.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a side cross-sectional view illustrating a refrigerant liquid discharge apparatus according to a first embodiment;

FIG. 2 is a cross-sectional view taken along line F2-F2 in FIG. 1;

FIG. 3 is a front view illustrating a first example of an information processing apparatus where the refrigerant liquid discharge apparatus illustrated in FIG. 1 is applied;

FIG. 4 is a plan view of the information processing apparatus illustrated in FIG. 3;

FIG. 5 is a side view of the information processing apparatus illustrated in FIG. 3;

FIG. 6 is a front view illustrating a second example of the information processing apparatus where the refrigerant liquid discharge apparatus illustrated in FIG. 1 is applied;

FIG. 7 is a plan view of the information processing apparatus illustrated in FIG. 6;

FIG. 8 is a side view of the information processing apparatus illustrated in FIG. 6;

FIG. 9 is a side cross-sectional view illustrating a refrigerant liquid discharge apparatus according to a second embodiment;

FIG. 10 is a cross-sectional view taken along line F10-F10 in FIG. 9;

FIG. 11 is a side cross-sectional view illustrating a refrigerant liquid discharge apparatus according to a third embodiment;

FIG. 12 is a side cross-sectional view illustrating a refrigerant liquid discharge apparatus according to a fourth embodiment;

FIG. 13 is a cross-sectional view taken along line F13-F13 in FIG. 12;

FIG. 14 is a side cross-sectional view illustrating a refrigerant liquid discharge apparatus according to a fifth embodiment;

FIG. 15 is a side cross-sectional view illustrating a refrigerant liquid discharge apparatus according to a comparative example;

FIG. 16 is a front view illustrating an information processing apparatus according to a comparative example where the refrigerant liquid discharge apparatus illustrated in FIG. 15 is applied;

FIG. 17 is a plan view of the information processing apparatus illustrated in FIG. 16; and

FIG. 18 is a side view of the information processing apparatus illustrated in FIG. 16.

### DESCRIPTION OF EMBODIMENTS

### First Embodiment

First, a first embodiment disclosed by the present application will be described.

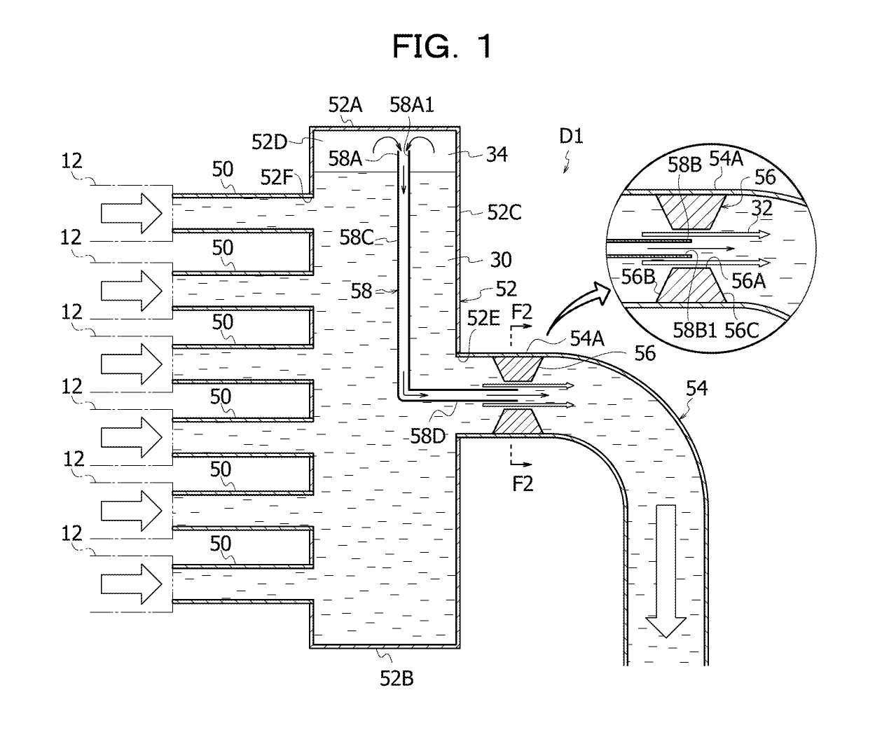

FIG. 1 is a side cross-sectional view illustrating a refrigerant liquid discharge apparatus D1 according to the first embodiment. As described later, the refrigerant liquid discharge apparatus D1 illustrated in FIG. 1 is provided on a refrigerant liquid discharge side of a cooling apparatus that cools a plurality of information processing units mounted in an information processing apparatus such as a server. The refrigerant liquid discharge apparatus D1 includes a plurality of pipes 50, a manifold 52, a main pipe 54, a throttle member 56, and a narrow tube 58.

The plurality of pipes 50 are aligned in a vertical direction. One ends of the plurality of pipes 50 are connected to a plurality of information processing units 12, respectively.

The manifold 52 is formed into a cylindrical shape whose vertical direction is a height direction. The manifold 52 has a top wall portion 52A, a bottom wall portion 52B, and a peripheral wall portion 52C. The other ends of the plurality of pipes 50 are connected to the peripheral wall portion 52C. The plurality of information processing units 12 and the manifold 52 are connected by the plurality of pipes 50, and refrigerant liquid 30 discharged from the plurality of information processing units 12 is collected to the manifold 52.

The main pipe 54 gradually bends from a horizontal direction to a vertically downward direction as it goes from one end to the other end. The one end of the main pipe 54 is connected to the peripheral wall portion 52C of the manifold 52. The refrigerant liquid 30 collected in the manifold 52 is discharged to, for example, a drainage facility or the like through the main pipe 54. The plurality of pipes 50, the manifold 52, and the main pipe 54 form a refrigerant liquid flow path on a refrigerant liquid discharge side.

The throttle member 56 is an example of a “throttle portion”. The throttle member 56 is a body separate from the main pipe 54 and is fixed to an inner circumferential surface of an inlet portion 54A of the main pipe 54. The throttle member 56 is formed into an annular shape and provided concentrically with the main pipe 54. In an axial center portion of the throttle member 56, a throttle hole 56A that penetrates along an axis direction of the throttle member 56 is formed. The throttle hole 56A is provided on the center of the main pipe 54.

An end face on an inlet side of the throttle member 56 is formed as an inlet side taper surface 56B inclined toward an axis direction center of the throttle member 56 (toward downstream side) as it goes toward the inside in the radial direction of the throttle member 56. An end face on an outlet side of the throttle member 56 is formed as an outlet side taper surface 56C inclined toward the axis direction center of the throttle member 56 (toward upstream side) as it goes toward the inside in the radial direction of the throttle member 56.

The diameter of the narrow tube 58 is sufficiently smaller than that of the main pipe 54. The narrow tube 58 extends from an inside upper portion 52D of the manifold 50 to the inside of the inlet portion 54A of the main pipe 54 and is inserted into the throttle hole 56A. Specifically, an inlet side end portion 58A of the narrow tube 58 is located in the inside upper portion 52D of the manifold 52, and an outlet side end portion 58B of the narrow tube 58 is located inside the inlet portion 54A of the main pipe 54 and inserted into the throttle hole 56A.

A portion 58C from the inlet side end portion 58A to a length direction central portion of the narrow tube 58 extends in a vertical direction. As an example, the length direction central portion of the narrow tube 58 is bent at a right angle, and a portion 58D from the length direction central portion of the narrow tube 58 to the outlet side end portion 58B extends in a horizontal direction.

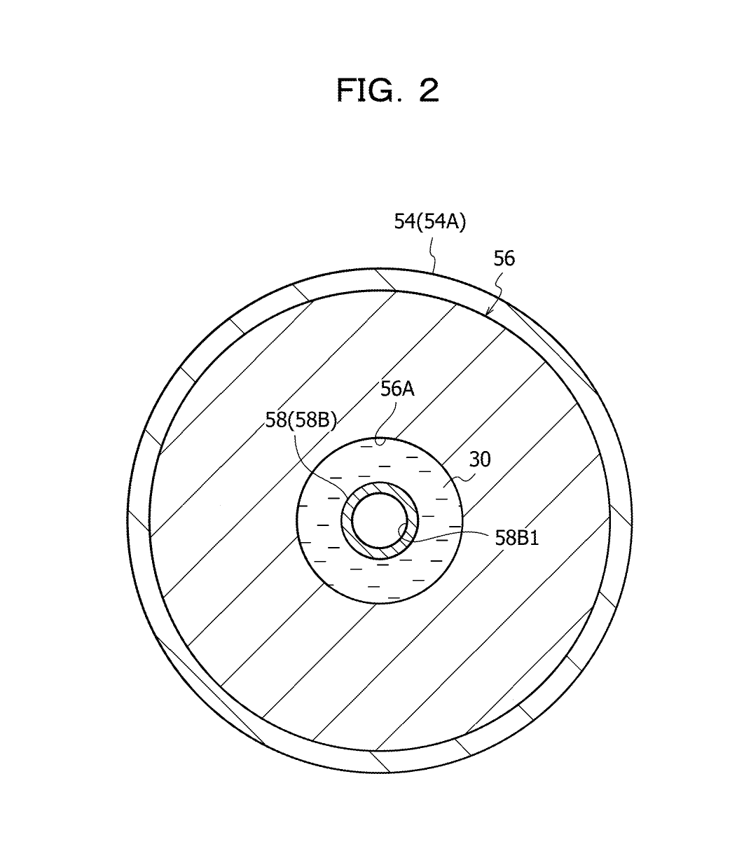

FIG. 2 is a cross-sectional view taken along line F2-F2 in FIG. 1. As illustrated in FIG. 2, a hole diameter of the throttle hole 56A (an inner diameter of the throttle member 56) is set to larger than an outer diameter of the narrow tube 58. The outlet side end portion 58B of the narrow tube 58 is inserted into the throttle hole 56A in a state where there is a gap between the outlet side end portion 58B and an inner circumferential surface of the throttle member 56. The outlet side end portion 58B of the narrow tube 58 is provided concentrically with the throttle member 56 that is formed into an annular shape.

As illustrated in FIG. 1, the outlet side end portion 58B of the narrow tube 58 is located at a position overlapping with the throttle hole 56A in the axis direction of the main pipe 54. Specifically, a range that overlaps with the throttle hole 56A in the axis direction of the main pipe 54 corresponds to a range of a length in the axis direction of the throttle hole 56A, and the outlet side end portion 58B of the narrow tube 58 is located in the range of the length in the axis direction of the throttle hole 56A. Thereby, an outlet 58B1 of the narrow tube 58 is located inside the throttle hole 56A. In the first embodiment, as an example, the outlet 58B1 of the narrow tube 58 is located at an axis direction central portion of the throttle hole 56A.

An outlet port 52E from the manifold 52 to the main pipe 54 is located at a position lower than an inlet port 52F from the pipe 50 arranged at the uppermost of the plurality of pipes 50 in the vertical direction to the manifold 52. In the first embodiment, as an example, the outlet port 52E from the manifold 52 to the main pipe 54 is located at a central portion in the height direction of the manifold 52. The pipe 50 arranged at the uppermost of the plurality of pipes 50 in the vertical direction is located lower than the top wall portion 52A of the manifold 52. An inlet 58A1 of the narrow tube 58 is located at a position higher than the inlet port 52F from the pipe 50 arranged at the uppermost of the plurality of pipes 50 in the vertical direction to the manifold 52.

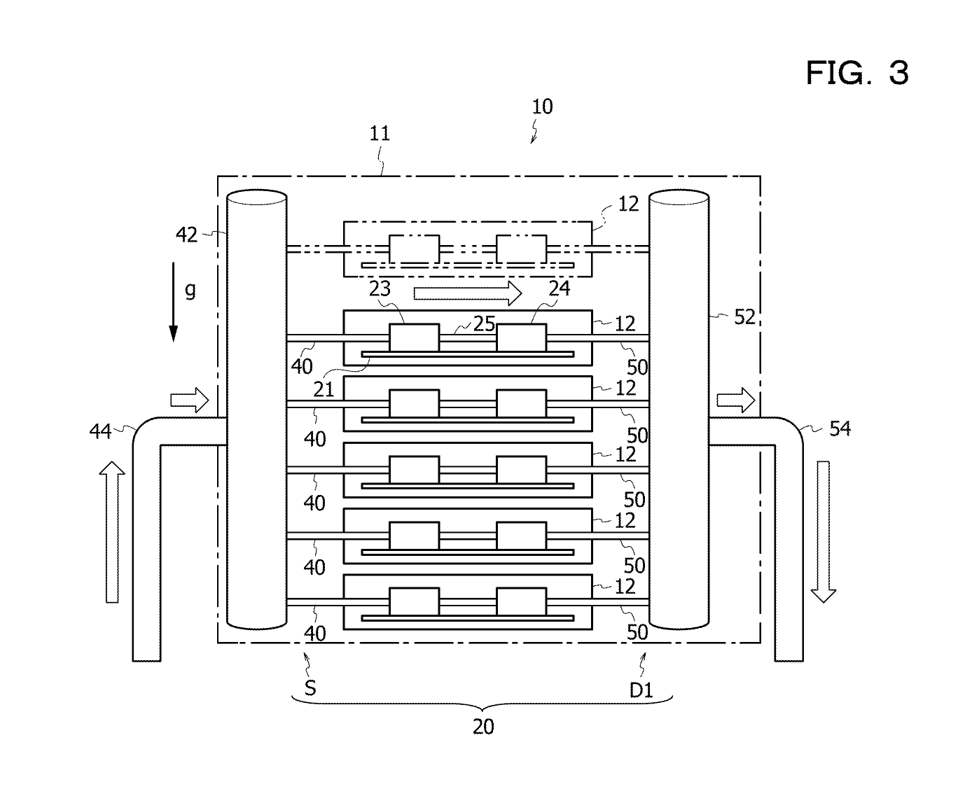

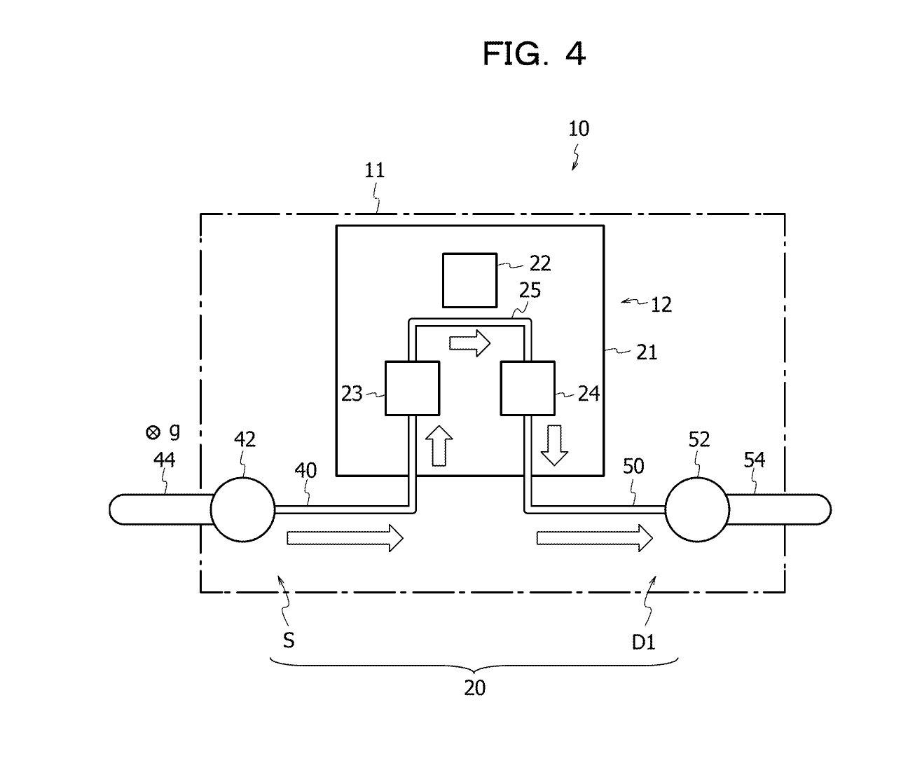

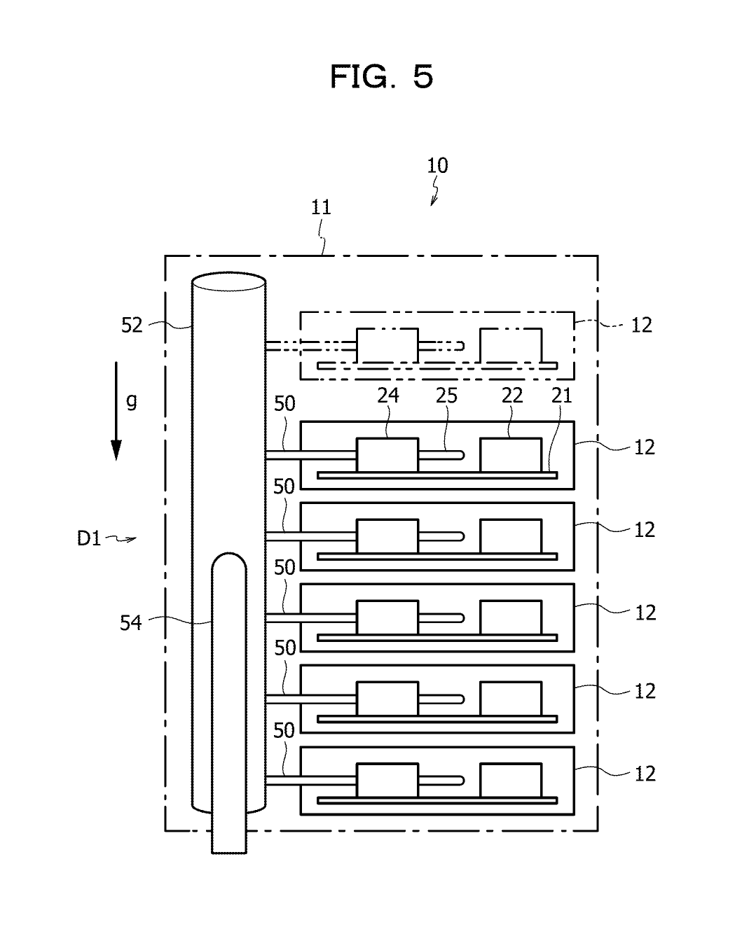

FIG. 3 is a front view illustrating a first example of an information processing apparatus 10 where the refrigerant liquid discharge apparatus D1 illustrated in FIG. 1 is applied. FIG. 4 is a plan view of the information processing apparatus 10 illustrated in FIG. 3. FIG. 5 is a side view of the information processing apparatus 10 illustrated in FIG. 3. Arrows g in FIGS. 3 to 5 indicate a vertically lower position.

As illustrated in FIGS. 3 to 5, the information processing apparatus 10 includes a rack 11, a plurality of information processing units 12, and a cooling apparatus 20. For example, the information processing apparatus 10 is a server, and the plurality of information processing units 12 are server units.

Each of the plurality of information processing units 12 has a flat plate-like shape and is horizontally mounted in the rack 11. The plurality of information processing units 12 are arranged in the vertical direction in the rack 11. Each information processing unit 12 is provided with a control substrate 21, and the control substrate 21 is mounted with heat generating components such as a control controller 22 and Central Processing Unit (CPUs) 23 and 24.

The cooling apparatus 20 is a water cooling type and includes a refrigerant liquid supply apparatus S in addition to the refrigerant liquid discharge apparatus D1 described above. The refrigerant liquid supply apparatus S includes a plurality of pipes 40, a manifold 42, and a main pipe 44.

The plurality of pipes 40 are arranged in the vertical direction. One ends of the plurality of pipes 40 are connected to the plurality of information processing units 12, respectively.

The manifold 42 is formed into a cylindrical shape whose vertical direction is a height direction. The other ends of the plurality of pipes 40 are connected to a peripheral wall portion of the manifold 42. The plurality of information processing units 12 and the manifold 42 are connected by the plurality of pipes 40, and refrigerant liquid is supplied to the plurality of information processing units 12 from the manifold 42.

The main pipe 44 bends from a vertically downward direction to a horizontal direction as it goes from one end to the other end. For example, a pump is connected to the one end of the main pipe 44, and the other end of the main pipe 44 is connected to the peripheral wall portion of the manifold 42. The refrigerant liquid is supplied to the manifold 42 from a water supply facility or the like through the main pipe 44 along with operation of the pump. For example, water is used as the refrigerant liquid. The plurality of pipes 40, the manifold 42, and the main pipe 44 form a refrigerant liquid flow path on a refrigerant liquid supply side.

In each information processing unit 12, as an example, the supply side pipe 40 is thermally connected to a heat conductive component provided to a first CPU 23, and the discharge side pipe 50 is thermally connected to a heat conductive component provided to a second CPU 24. The supply side pipe 40 and the discharge side pipe 50 are connected by a pipe 25. The supply side pipe 40, the discharge side pipe 50, and the pipe 25 that connects the pipe 40 with the pipe 50 may be formed by one pipe or may be formed by a plurality of pipes that are connected together.

Next, functions and effects of the first embodiment will be described along with an operation of the cooling apparatus 20 in the information processing apparatus 10.

In the information processing apparatus 10, the refrigerant liquid that passes through the manifold 42 from the main pipe 44 is supplied to each information processing unit 12 through the plurality of pipes 40. The refrigerant liquid supplied to the information processing unit 12 cools the heat generating components such as the control controller 22 and the CPUs 23 and 24 by performing heat exchange with the heat generating components when flowing from the pipe 40 to the pipe 50. The refrigerant liquid discharged from each information processing unit 12 is collected in the manifold 52 through the plurality of pipes 50, and the refrigerant liquid collected in the manifold 52 is discharged through the main pipe 54.

By the way, in the information processing apparatus 10 described above, air may be mixed into or may remain in the refrigerant liquid flow path through which the refrigerant liquid flows. For example, when the information processing apparatus 10 is newly introduced, from a viewpoint of measures against water leakage and the like, an introduction operation is generally performed in a state where the refrigerant liquid flow path is empty, and the refrigerant liquid is injected into the refrigerant liquid flow path after the introduction operation. At this time, the air remains in the refrigerant liquid flow path. However, it is difficult to completely remove the air. Further, while the information processing apparatus 10 is being operated, an information processing unit 12 that may be replaced occurs due to failure of an electronic component or the like. When the information processing unit 12 is replaced, air in the information processing unit 12 or external air intrudes into the refrigerant liquid flow path.

When air is mixed into or remains in the refrigerant liquid flow path through which the refrigerant liquid flows as described above, there is a risk that the flow of the refrigerant liquid is obstructed. When the flow of the refrigerant liquid is obstructed in this way, flow rate differences of the refrigerant liquid supplied to the plurality of information processing units 12 increase, so that there is a risk that an information processing unit 12 that may not obtain a desired flow rate is not cooled sufficiently. For example, the air mixed into the refrigerant liquid flow path is carried to the inside upper portion 52D of the manifold 52 illustrated in FIG. 1. When air 34 remains in the inside upper portion 52D of the manifold 52, the flow of the refrigerant liquid 30 in the uppermost pipe 50 is obstructed, so that there is a risk that an information processing unit 12 connected to the uppermost pipe 50 is not cooled sufficiently.

Further, when replacing a pump connected to the main pipe 44 illustrated in FIG. 3 for maintenance or the like, there is a case where a flow rate decrease or a flow stoppage of the refrigerant liquid occurs for only a short time. In this case, when air flows back into the information processing unit 12, a heat exchange unit between the refrigerant liquid and the heat generating components in the information processing unit 12 may be heated without the refrigerant liquid.

However, as illustrated in FIG. 1, in the refrigerant liquid discharge apparatus D1 according to the first embodiment, the throttle member 56 having the throttle hole 56A that penetrates in the axis direction of the main pipe 54 is provided inside the inlet portion 54A of the main pipe 54. Further, the narrow tube 58 that extends from the inside upper portion 52D of the manifold 52 to the inside of the main pipe 54 is inserted into the throttle hole 56A.

Therefore, when the refrigerant liquid 30 passes through the throttle member 56, the refrigerant liquid 30 is throttled by the throttle member 56, so that a high-speed flow 32 whose flow speed is high is formed in the refrigerant liquid 30. Thereby, a pressure difference occurs between the inlet side and the outlet side of the narrow tube 58. Specifically, the outlet side of the narrow tube 58 becomes more negative pressure than its surroundings due to the high-speed flow 32. On the other hand, the pressure of the inlet side of the narrow tube 58 becomes relatively higher than the pressure of the outlet side of the narrow tube 58 due to the pressure in the manifold 52.

As described above, a pressure difference occurs between the inlet side and the outlet side of the narrow tube 58, so that a suction force is applied to the outlet side of the narrow tube 58. Therefore, the air 34 in the inside upper portion 52D of the manifold 52 is sucked from the inlet 58A1 of the narrow tube 58 and discharged from the outlet 58B1 of the narrow tube 58. The air 34 discharged from the outlet 58B1 of the narrow tube 58 is discharged through the main pipe 54 along with the refrigerant liquid 30 that has passed through the throttle member 56. After the air 34 in the inside upper portion 52D of the manifold 52 is discharged through the narrow tube 58 and the main pipe 54, the refrigerant liquid 30 inside the manifold 52 is discharged through the narrow tube 58 and the main pipe 54.

As described above, according to the refrigerant liquid discharge apparatus D1 according to the first embodiment, it is possible to discharge the air 34 present in the inside upper portion 52D of the manifold 52 through the narrow tube 58 and the main pipe 54. Therefore, even when the air 34 is mixed into the refrigerant liquid flow path through which the refrigerant liquid 30 flows, if the air 34 is carried to the inside upper portion 52D of the manifold 52, the air 34 may be removed. Therefore, it is possible to keep the flow of the refrigerant liquid 30 from being obstructed. Thereby, the refrigerant liquid 30 may be uniformly supplied to the plurality of information processing units 12, so that it is possible to uniformly cool the plurality of information processing units 12.

Further, it is also possible to discharge air that has flowed back into the information processing unit 12, so that it is possible to keep the heat exchange unit between the refrigerant liquid 30 and the heat generating components in the information processing unit 12 from being heated without the refrigerant liquid.

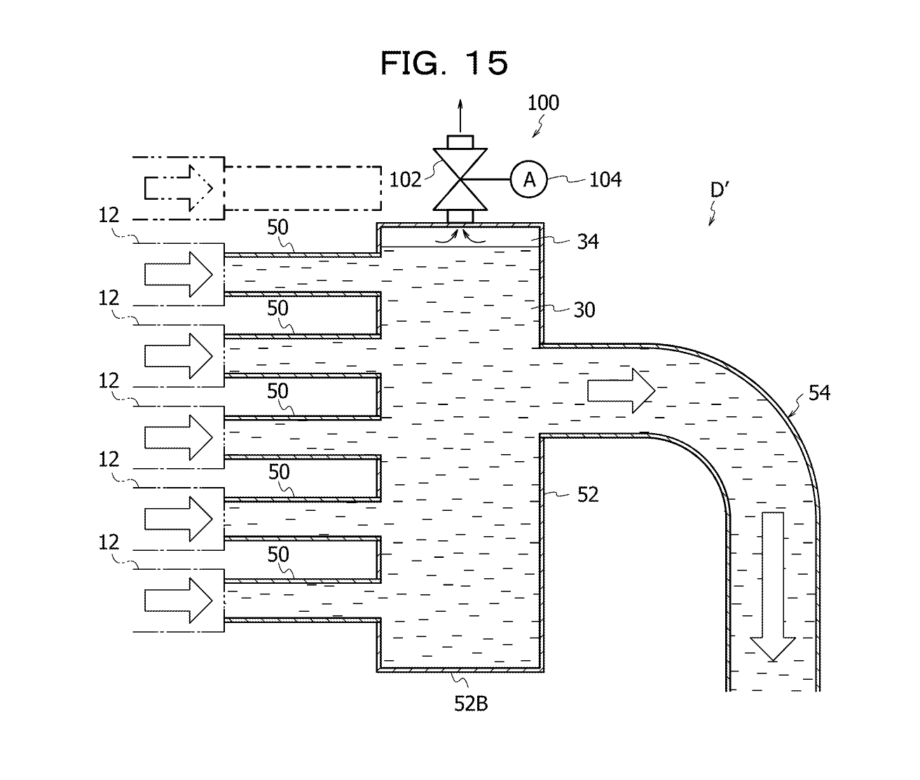

Further, according to the first embodiment, the effects described below are obtained in addition to the effects described above. Here, a comparative example will be described in order to clarify the additional effects of the first embodiment. FIG. 15 is a side cross-sectional view illustrating a refrigerant liquid discharge apparatus D′ according to the comparative example.

As illustrated in FIG. 15, the refrigerant liquid discharge apparatus D′ according to the comparative example includes an air vent mechanism 100 instead of the throttle member 56 and the narrow tube 58 (see FIG. 1) as compared with the refrigerant liquid discharge apparatus D1 according to the first embodiment described above. The air vent mechanism 100 is provided on the top wall portion 52A of the manifold 52. The air vent mechanism 100 has an air vent valve 102 and an actuator 104 that opens and closes the air vent valve 102. When the actuator 104 operates and the air vent valve 102 is released, the air 34 in the inside upper portion 52D of the manifold 52 is discharged through the vent valve 102.

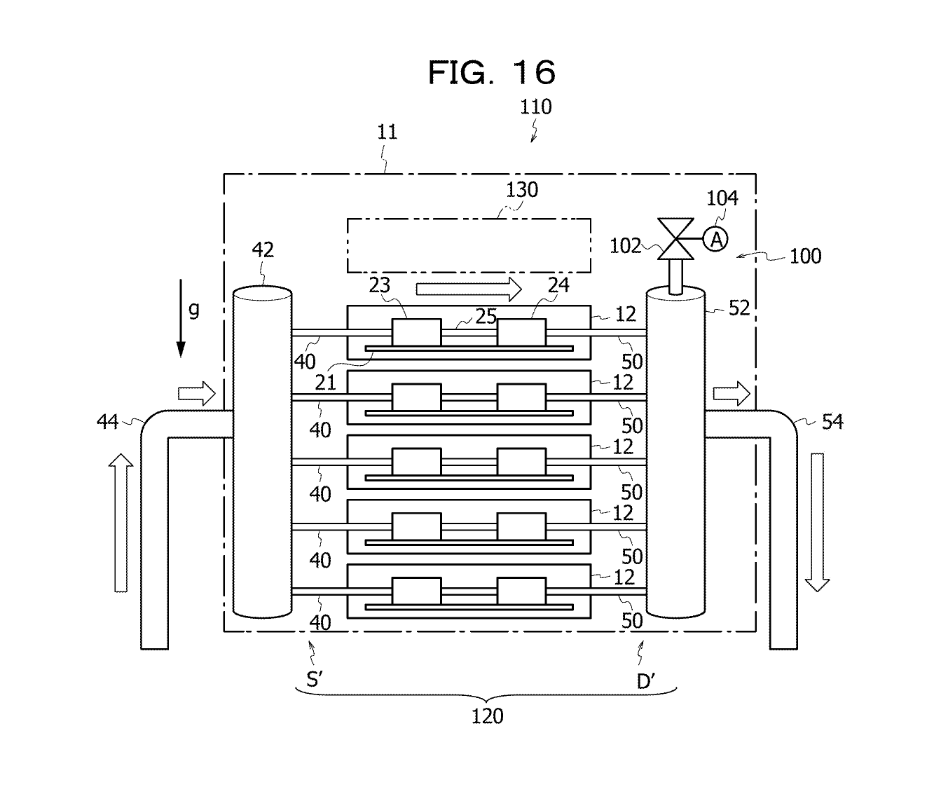

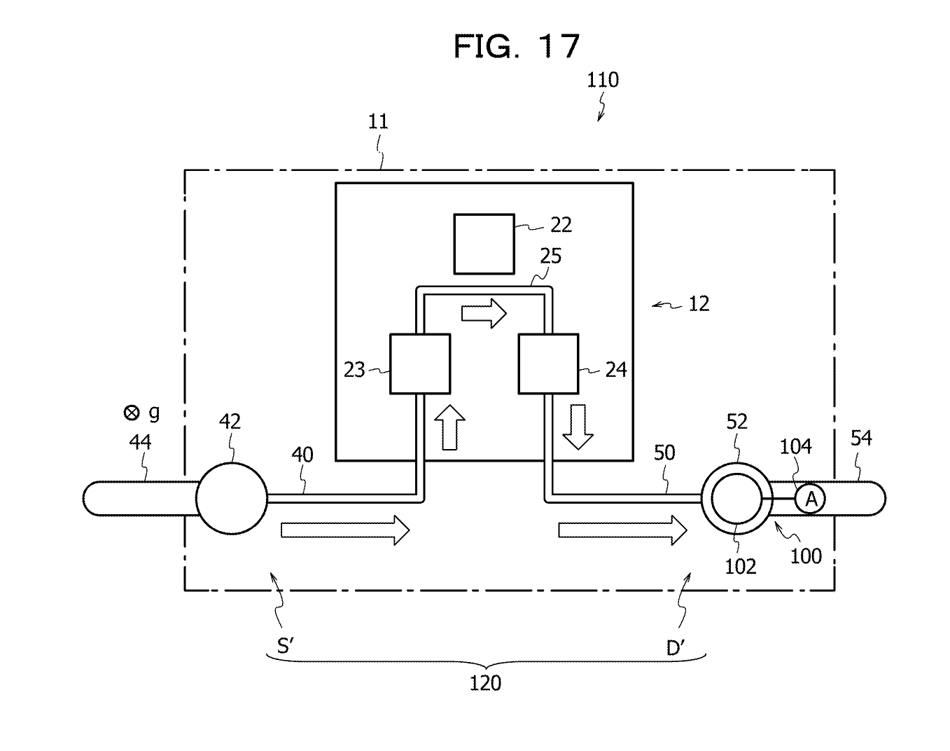

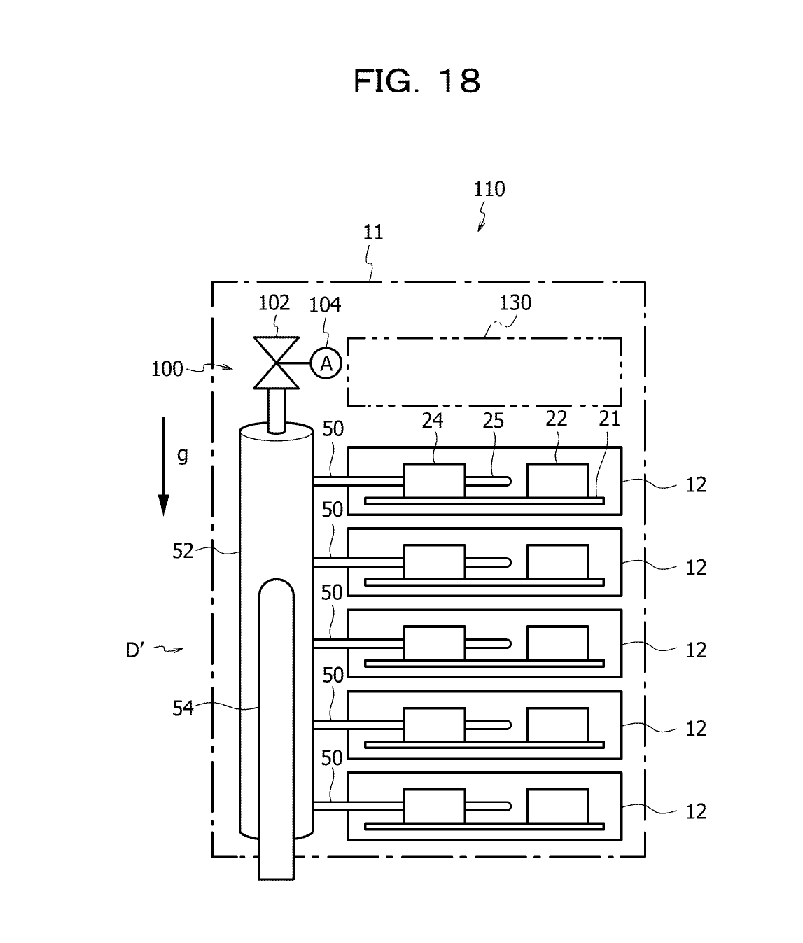

FIG. 16 is a front view illustrating an information processing apparatus 110 according to the comparative example where the refrigerant liquid discharge apparatus illustrated in FIG. 15 is applied. FIG. 17 is a plan view of the information processing apparatus 110 illustrated in FIG. 16. FIG. 18 is a side view of the information processing apparatus 110 illustrated in FIG. 16.

As illustrated in FIGS. 16 to 18, the information processing apparatus 110 according to the comparative example includes a rack 11 and a plurality of information processing units 12 in the same manner as the information processing apparatus 10 (see FIGS. 3 to 5) according to the first embodiment described above. Further, the information processing apparatus 110 according to the comparative example includes a cooling apparatus 120.

The cooling apparatus 120 includes a refrigerant liquid supply apparatus S′ in addition to the refrigerant liquid discharge apparatus D′ described above. The refrigerant liquid supply apparatus S′ includes a plurality of pipes 40, a manifold 42, and a main pipe 44 in the same manner as the refrigerant liquid supply apparatus S (see FIGS. 3 to 5) according to the first embodiment described above.

However, the information processing apparatus 110 where the refrigerant liquid discharge apparatus D′ according to the comparative example is applied has a problem described below. That is, the refrigerant liquid discharge apparatus D′ according to the comparative example is provided with the air vent mechanism 100. The air vent mechanism 100 is provided on the top wall portion 52A of the manifold 52 in order to vent the air. Therefore, the information processing apparatus 110, where the refrigerant liquid discharge apparatus D′ according to the comparative example is applied, is provided with an installation space of the air vent mechanism 100 in the rack 11. Therefore, a space 130 is generated, which has a height corresponding to the height of the air vent mechanism 100 and where the information processing apparatus 10 may not be mounted in the rack 11.

Therefore, in the information processing apparatus 110 according to the comparative example, the number of the information processing units 12 that may be mounted is restricted or the height where the information processing units 12 are mounted (the height of the rack 11) is restricted. Further, in the air vent mechanism 100, the inside and the outside of the manifold 52 are separated by the air vent valve 102, so that if an abnormality such as clogging occurs in the air vent valve 102, there is a risk that the refrigerant liquid 30 inside the manifold 50 leaks to the outside.

On the other hand, in the refrigerant liquid discharge apparatus D1 according to the first embodiment illustrated in FIG. 1, the throttle member 56 and the narrow tube 58 are provided instead of the air vent mechanism 100 (see FIG. 15) described above. The throttle member 56 and the narrow tube 58 are provided inside the manifold 52 and the main pipe 54. Therefore, an installation space for the air vent mechanism 100 does not have to be provided over the manifold 52, which is provided in the comparative example described above. Thereby, the manifold 52 may be expanded upward as compared with the comparative example, so that it is possible to increase the number of the information processing units 12 that may be mounted. Alternatively, it is possible to lower the height of the mounted information processing units 12 (the height of the rack 11) by the height of the air vent mechanism 100 over the manifold 52.

In a first example of the information processing apparatus 10 according to the first embodiment illustrated in FIGS. 3 to 5, the manifold 52 is expanded upward as compared with the comparative example and the number of the information processing units 12 that may be mounted is increased by the uppermost information processing unit 12 indicated by two-dot chain lines.

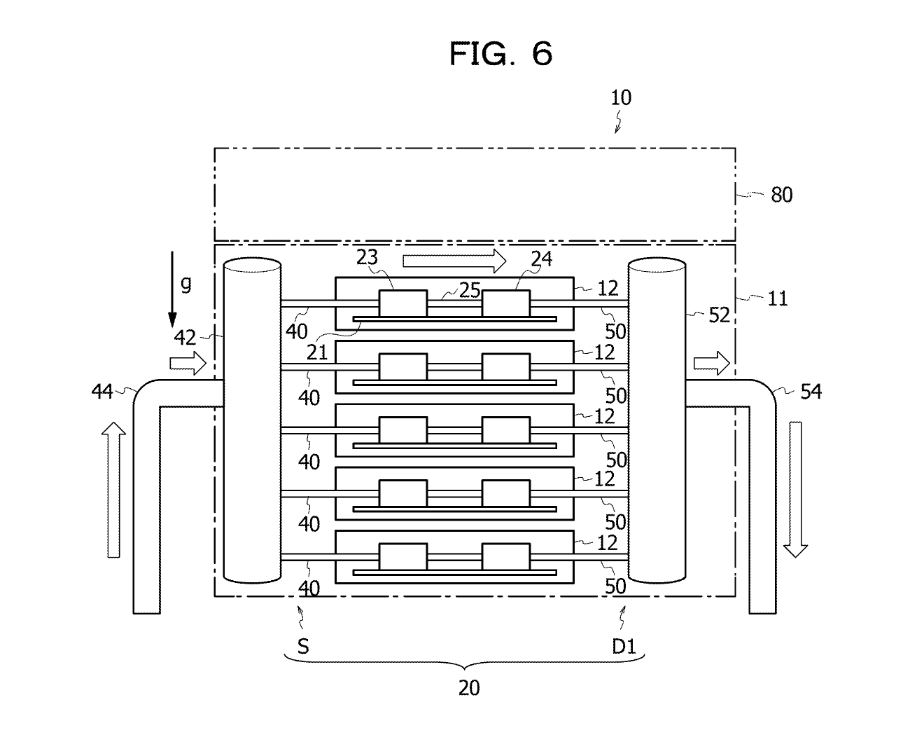

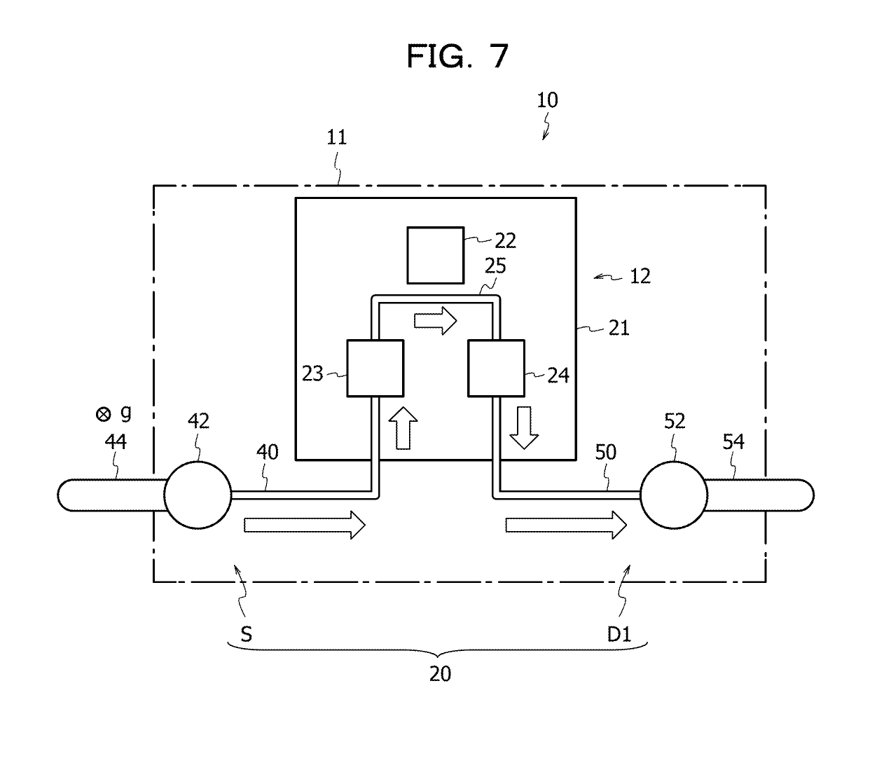

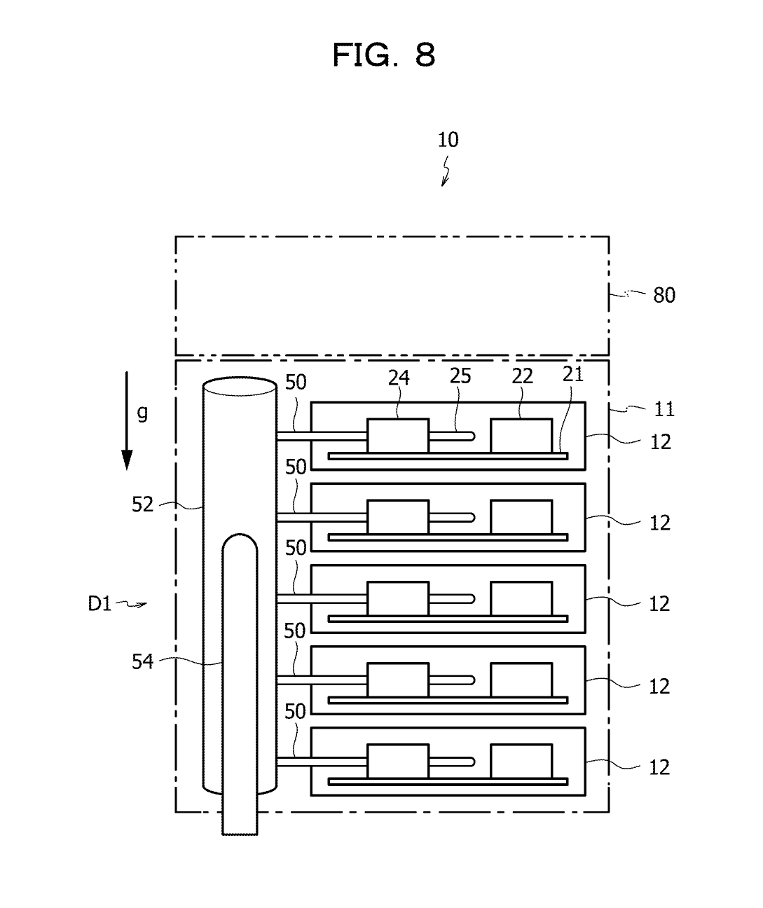

On the other hand, FIGS. 6 to 8 illustrate a second example of the information processing apparatus 10 according to the first embodiment. In the second example of the information processing apparatus 10 according to the first embodiment illustrated in FIGS. 6 to 8, the height of the mounted information processing units 12 (the height of the rack 11) is decreased by a space 80 indicated by a two-dot chain line as compared with the comparative example.

In this way, according to the information processing apparatus 10 where the refrigerant liquid discharge apparatus D1 according to the first embodiment is applied, it is possible to increase the number of the information processing units 12 that may be mounted or it is possible to lower the height of the mounted information processing units 12 (the height of the rack 11).

Further, according to the information processing apparatus 10 where the refrigerant liquid discharge apparatus D1 according to the first embodiment is applied, a portion where there is a risk of liquid leakage is removed by removing the air vent valve 102 from the manifold 52. Therefore, it is possible to increase the reliability of the information processing apparatus 10. Further, by removing the air vent mechanism 100 including the air vent valve 102 and the actuator 104, it is possible to reduce cost as compared with the comparative example.

Next, modified examples of the first embodiment will be described.

In the first embodiment described above, one narrow tube 58 is used. However, a plurality of narrow tubes 58 may be used. Further, in the throttle member 56, a plurality of throttle holes 56A may be formed corresponding the plurality of narrow tubes 58, respectively.

In the first embodiment described above, the throttle member 56 separate from the main pipe 54 is used. However, for example, a throttle portion, which is formed by throttling a part of the main pipe 54 and is integrally formed with the main pipe 54, may be used.

In the first embodiment, the throttle member 56 is provided in the inlet portion 54A of the main pipe 54. However, the throttle member 56 may be provided on the downstream side of the inlet portion 54A of the main pipe 54.

In the first embodiment, the outlet 58B1 of the narrow tube 58 is located inside the throttle hole 56A. However, if the outlet 58B1 of the narrow tube 58 is opened by the high-speed flow 32 where the flow speed of the refrigerant liquid 30 is high and a desired suction force is obtained on the outlet side of the narrow tube 58, the outlet 58B1 of the narrow tube 58 may be located on the upstream side or the downstream side of the throttle hole 56A.

In the first embodiment, the information processing apparatus 10 is a server as an example. However, the information processing apparatus 10 may be other than a server.

The plurality of modified examples described above may be appropriately combined together.

### Second Embodiment

Next, a second embodiment disclosed by the present application will be described.

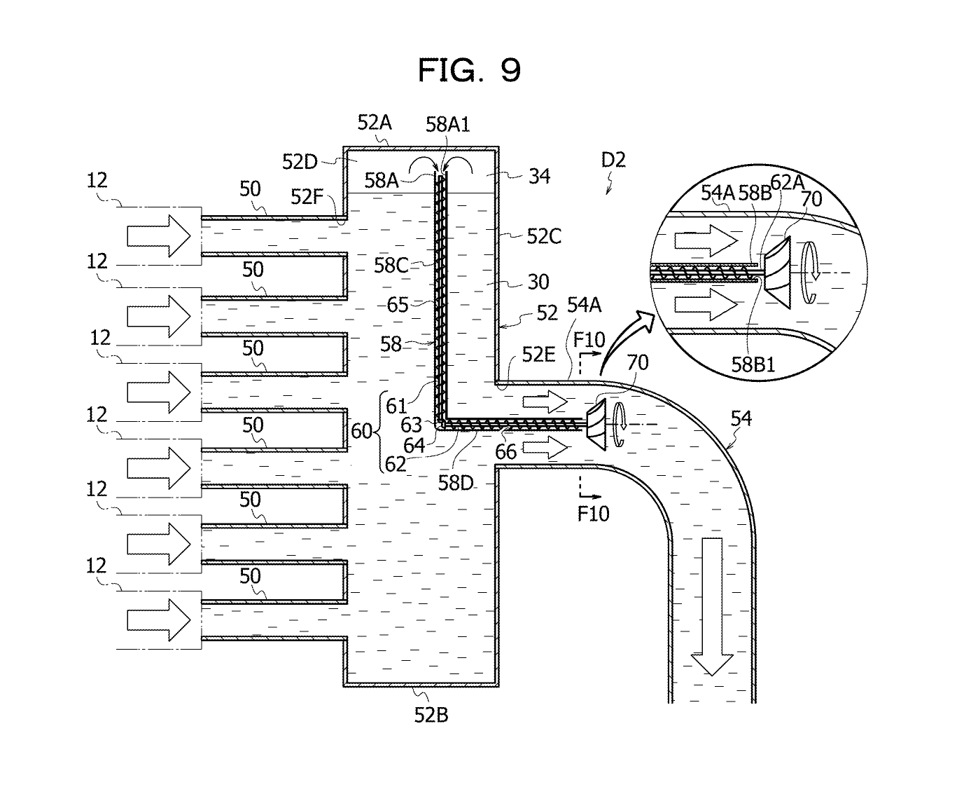

FIG. 9 is a side cross-sectional view illustrating a refrigerant liquid discharge apparatus D2 according to the second embodiment. In the same manner as the refrigerant liquid discharge apparatus D1 (see FIG. 1) according to the first embodiment, the refrigerant liquid discharge apparatus D2 illustrated in FIG. 9 is applied on the discharge side of the cooling apparatus 20 provided in the information processing apparatus 10 (see FIGS. 3 to 8). The refrigerant liquid discharge apparatus D2 includes a plurality of pipes 50, a manifold 52, a main pipe 54, a narrow tube 58, a shaft 60, and an impeller 70.

The plurality of pipes 50, the manifold 52, the main pipe 54, and the narrow tube 58 are the same as those in the first embodiment.

The shaft 60 has a first shaft 61 and a second shaft 62. The first shaft 61 is provided inside a portion 58C from an end portion on the inlet side of the narrow tube 58 to a length direction central portion of the narrow tube 58 and extends along an axis direction (vertical direction) of the portion 58C. The second shaft 62 is provided inside a portion 58D from the length direction central portion of the narrow tube 58 to an end portion on the outlet side of the narrow tube 58 and extends along an axis direction (horizontal direction) of the portion 58D.

A first gear 63 is provided to one end portion of the first shaft 61, and a second gear 64 is provided to one end portion of the second shaft 62. The first gear 63 and the second gear 64 are bevel gears and engaged with each other. The other end portion 62A of the second shaft 62 corresponds to an “end portion protruding from an outlet of a narrow tube in a shaft” and protrudes from the outlet 58B1 of the narrow tube 58.

The impeller 70 is provided inside the inlet portion 54A of the main pipe 54 and connected to the other end portion 62A of the second shaft 62. The outer diameter of the impeller 70 is set to greater than the outer diameter of the narrow tube 58 and smaller than the inner diameter of the main pipe 54.

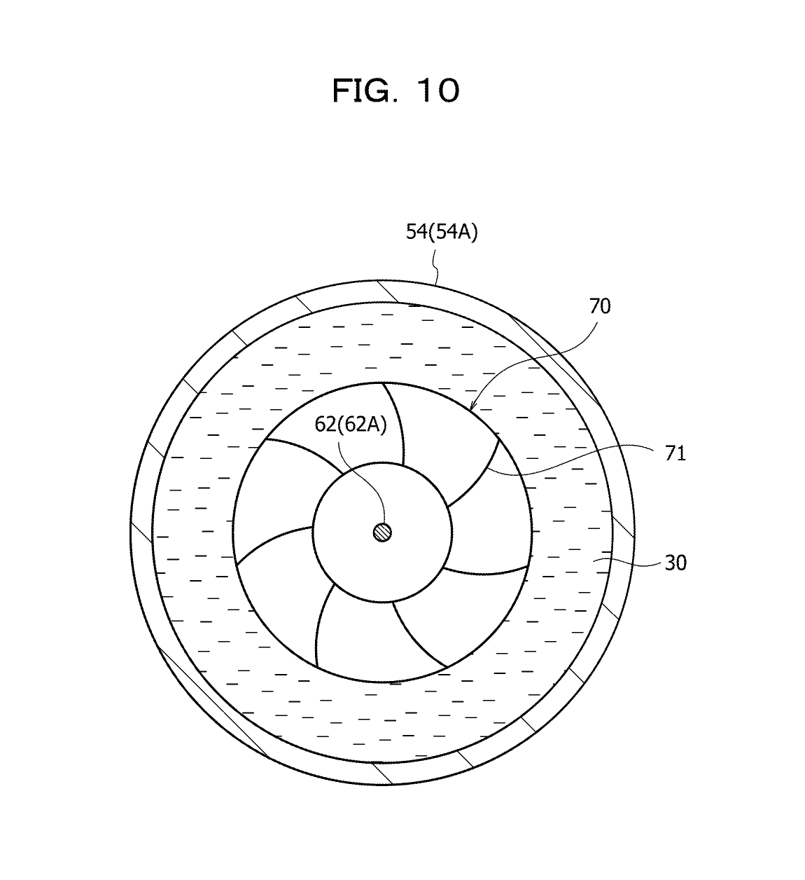

FIG. 10 is a cross-sectional view taken along line F10-F10 in FIG. 9. As illustrated in FIG. 10, the impeller 70 is radially provided with a plurality of blades 71. The impeller 70 is rotated by flow of the refrigerant liquid 30 inside the inlet portion 54A of the main pipe 54.

As illustrated in FIG. 9, a first spiral portion 65 having a spiral shape around a shaft direction of the first shaft 61 is provided on an outer circumferential portion of the first shaft 61, and a second spiral portion 66 having a spiral shape around a shaft direction of the second shaft 62 is provided on an outer circumferential portion of the second shaft 62. The first spiral portion 65 and the second spiral portion 66 are examples of a “spiral portion”.

The first spiral portion 65 and the second spiral portion 66 have a spiral shape in a direction in which fluid is delivered from the inside upper portion 52D of the manifold 52 to the outlet 58B1 of the narrow tube 58 accompanying the rotation of the impeller 70. The fluid in this case is the air 34 when there is the air 34 in the inside upper portion 52D of the manifold 52 and is the refrigerant liquid 30 when the inside upper portion 52D of the manifold 52 is filled with the refrigerant liquid 30.

Next, functions and effects of the second embodiment will be described along with an operation of the refrigerant liquid discharge apparatus D2 described above.

In the refrigerant liquid discharge apparatus D2 according to the second embodiment, when the refrigerant liquid 30 flows inside the inlet portion 54A of the main pipe 54, the impeller 70 is rotated by the flow of the refrigerant liquid 30. When the impeller 70 rotates, the second shaft 62 rotates along with the impeller 70, a rotational force of the second shaft 62 is transmitted to the first shaft 61 through the second gear 64 and the first gear 63, and the first shaft 61 rotates. When the first shaft 61 and the second shaft 62 rotate, the first spiral portion 65 rotates along with the first shaft 61 and the second spiral portion 66 rotates along with the second shaft 62.

When the first spiral portion 65 and the second spiral portion 66 rotate in this way, the air 34 in the inside upper portion 52D of the manifold 52 is taken into the narrow tube 58 from the inlet 58A1 of the narrow tube 58. The air 34 is involved in the first spiral portion 65 and the second spiral portion 66 and discharged from the outlet 58B1 of the narrow tube 58. The air 34 discharged from the outlet 58B1 of the narrow tube 58 is discharged through the main pipe 54 along with the refrigerant liquid 30 that has passed through the throttle member 56. After the air 34 in the inside upper portion 52D of the manifold 52 is discharged through the narrow tube 58 and the main pipe 54, the refrigerant liquid 30 inside the manifold 52 is discharged through the narrow tube 58 and the main pipe 54.

As described above, according to the refrigerant liquid discharge apparatus D2 according to the second embodiment, it is possible to discharge the air 34 present in the inside upper portion 52D of the manifold 52 through the narrow tube 58 and the main pipe 54. Therefore, even when the air 34 is mixed into the refrigerant liquid flow path through which the refrigerant liquid 30 flows, if the air 34 is carried to the inside upper portion 52D of the manifold 52, the air 34 may be removed. Therefore, it is possible to keep the flow of the refrigerant liquid 30 from being obstructed. Thereby, the refrigerant liquid 30 may be uniformly supplied to the plurality of information processing units 12, so that it is possible to uniformly cool the plurality of information processing units 12.

Further, it is also possible to discharge air that has flowed back into the information processing unit 12, so that it is possible to keep the heat exchange unit between the refrigerant liquid 30 and the heat generating components in the information processing unit 12 from being heated without the refrigerant liquid.

The refrigerant liquid discharge apparatus D2 according to the second embodiment is provided with the narrow tube 58, the first shaft 61, the second shaft 62, and the impeller 70 instead of the air vent mechanism 100 (see FIG. 15) described above. The narrow tube 58, the first shaft 61, the second shaft 62, and the impeller 70 are provided inside the manifold 52 and the main pipe 54.

Therefore, an installation space for the air vent mechanism 100 does not have to be provided over the manifold 52, which is provided in the comparative example described above. Thereby, the manifold 52 may be expanded upward as compared with the comparative example, so that it is possible to increase the number of the information processing units 12 that may be mounted. Alternatively, it is possible to lower the height of the mounted information processing units 12 (the height of the rack 11) by the height of the air vent mechanism 100 over the manifold 52.

Further, a portion where there is a risk of liquid leakage is removed by removing the air vent valve 102 from the manifold 52. Therefore, it is possible to increase the reliability of the information processing apparatus 10. Further, by removing the air vent mechanism 100 including the air vent valve 102 and the actuator 104, it is possible to reduce cost as compared with the comparative example.

Next, modified examples of the second embodiment will be described.

In the second embodiment described above, one narrow tube 58 is used. However, a plurality of narrow tubes 58 may be used. The shaft 60 and the impeller 70 may be provided to each of the plurality of narrow tubes 58.

Also in the second embodiment described above, the information processing apparatus 10 may be other than a server.

The plurality of modified examples described above may be appropriately combined together.

### Third Embodiment

Next, a third embodiment disclosed by the present application will be described.

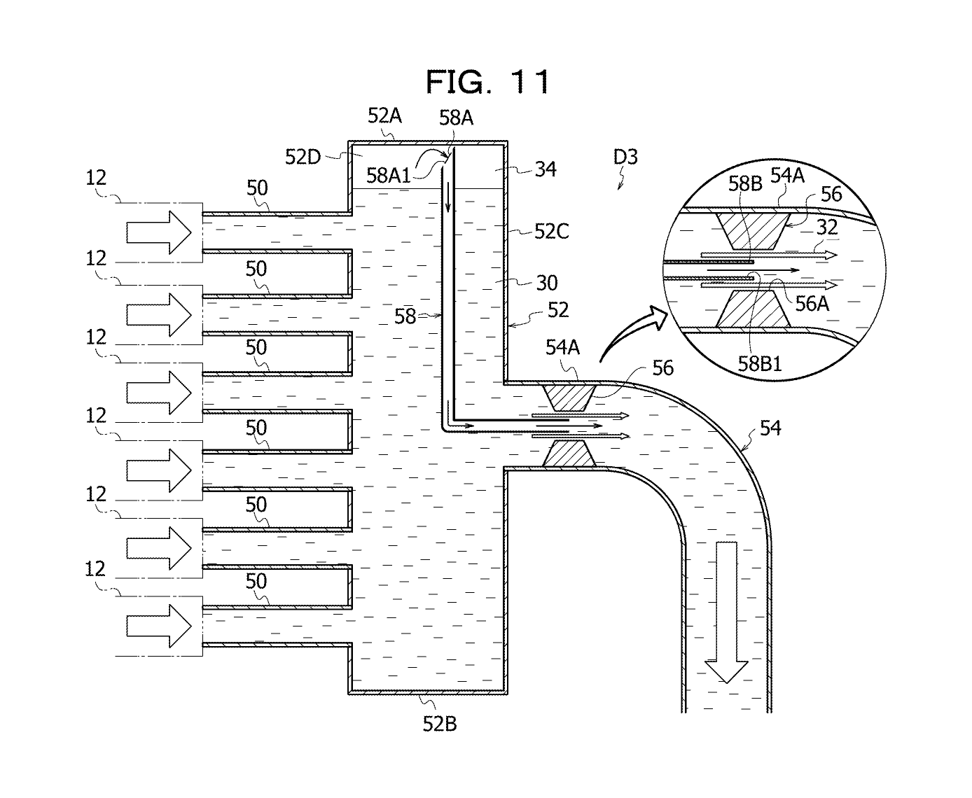

FIG. 11 is a side cross-sectional view illustrating a refrigerant liquid discharge apparatus D3 according to the third embodiment. In the same manner as the refrigerant liquid discharge apparatus D1 (see FIG. 1) according to the first embodiment, the refrigerant liquid discharge apparatus D3 illustrated in FIG. 11 is applied on the discharge side of the cooling apparatus 20 provided in the information processing apparatus 10 (see FIGS. 3 to 8).

As described below, a configuration of the refrigerant liquid discharge apparatus D3 according to the third embodiment is changed from the configuration of the refrigerant liquid discharge apparatus D1 according to the first embodiment described above. That is, the inlet side end portion 58A of the narrow tube 58 is diagonally cut, and the inlet 58A1 of the narrow tube 58 faces obliquely upward as an example of a direction crossing the length direction of the narrow tube 58. The inlet side end portion 58A of the narrow tube 58 is abutted against the top wall portion 52A of the manifold 52.

In this way, in the refrigerant liquid discharge apparatus D3 according to the third embodiment, the inlet side end portion 58A of the narrow tube 58 is abutted against the top wall portion 52A of the manifold 52. Therefore, it is possible to improve manufacturability of the refrigerant liquid discharge apparatus D3 by suppressing variation of the position of the narrow tube 58 (in particular, the position of the inlet 58A1 of the narrow tube 58).

Further, even when the inlet side end portion 58A of the narrow tube 58 is abutted against the top wall portion 52A of the manifold 52, the inlet 58A1 of the narrow tube 58 faces obliquely upward. Therefore, it is possible to take in the air 34 present in the inside upper portion 52D of the manifold 52 from the inlet 58A1 of the narrow tube 58.

In the third embodiment described above, the inlet side end portion 58A of the narrow tube 58 is diagonally cut, and the inlet 58A1 of the narrow tube 58 faces obliquely upward. However, it is allowed that a top end of the narrow tube 58 is cut horizontally and abutted against the top wall portion 52A of the manifold 52 and an inlet 58A1 that opens in the horizontal direction is formed below the top end. In this case, the top end of the narrow tube 58 corresponds to an example of an “inlet side end portion of a narrow tube”. Further, the horizontal direction in which the inlet 58A1 opens corresponds to an example of a “direction crossing a length direction of a plurality of narrow tubes”.

Although the refrigerant liquid discharge apparatus D3 according to the third embodiment is an apparatus obtained by changing the configuration of the refrigerant liquid discharge apparatus D1 according to the first embodiment described above, the refrigerant liquid discharge apparatus D3 may be an apparatus obtained by changing the configuration of the refrigerant liquid discharge apparatus D2 according to the second embodiment described above.

The modified examples of the first and the second embodiments described above may be appropriately applied to the third embodiment.

### Fourth Embodiment

Next, a fourth embodiment disclosed by the present application will be described.

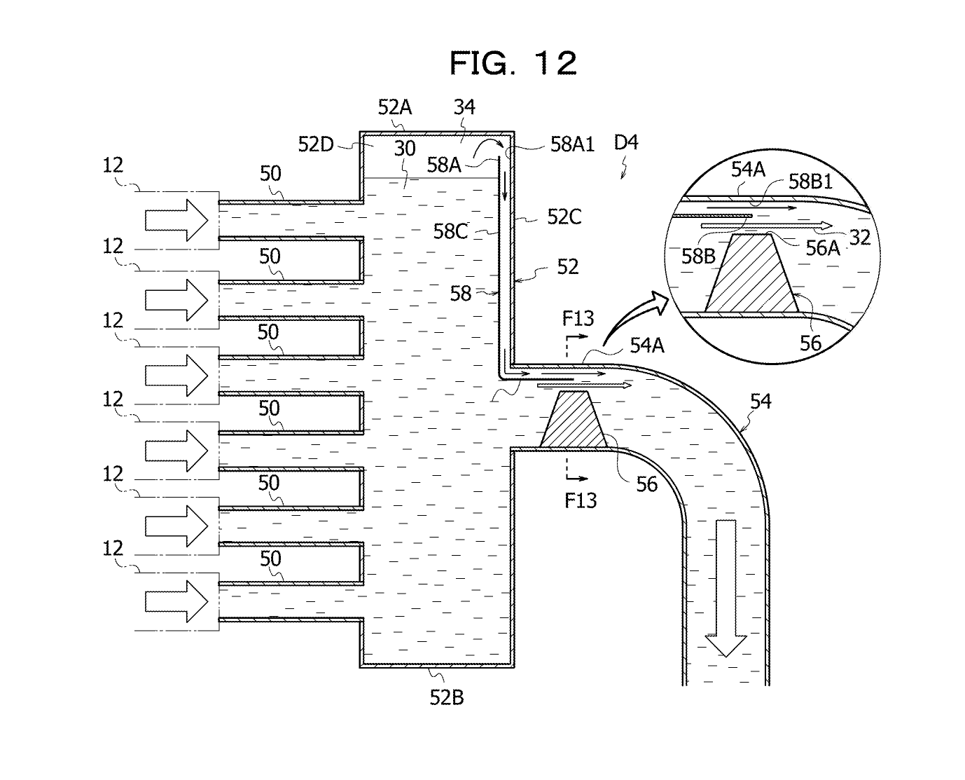

FIG. 12 is a side cross-sectional view illustrating a refrigerant liquid discharge apparatus D4 according to the fourth embodiment. In the same manner as the refrigerant liquid discharge apparatus D1 (see FIG. 1) according to the first embodiment, the refrigerant liquid discharge apparatus D4 illustrated in FIG. 12 is applied on the discharge side of the cooling apparatus 20 provided in the information processing apparatus 10 (see FIGS. 3 to 8).

As described below, a configuration of the refrigerant liquid discharge apparatus D4 according to the fourth embodiment is changed from the configuration of the refrigerant liquid discharge apparatus D1 according to the first embodiment described above. That is, a portion 58C from an end portion on the inlet side of the narrow tube 58 to a length direction central portion of the narrow tube 58 is fixed in a state where the portion 58C is in contact with the inner circumferential surface of the peripheral wall portion 52C of the manifold 52. Further, a portion 58D from the length direction central portion of the narrow tube 58 to an end portion on the outlet side of the narrow tube 58 is fixed in a state where the portion 58D is in contact with the inner circumferential surface of the inlet portion 54A of the main pipe 54.

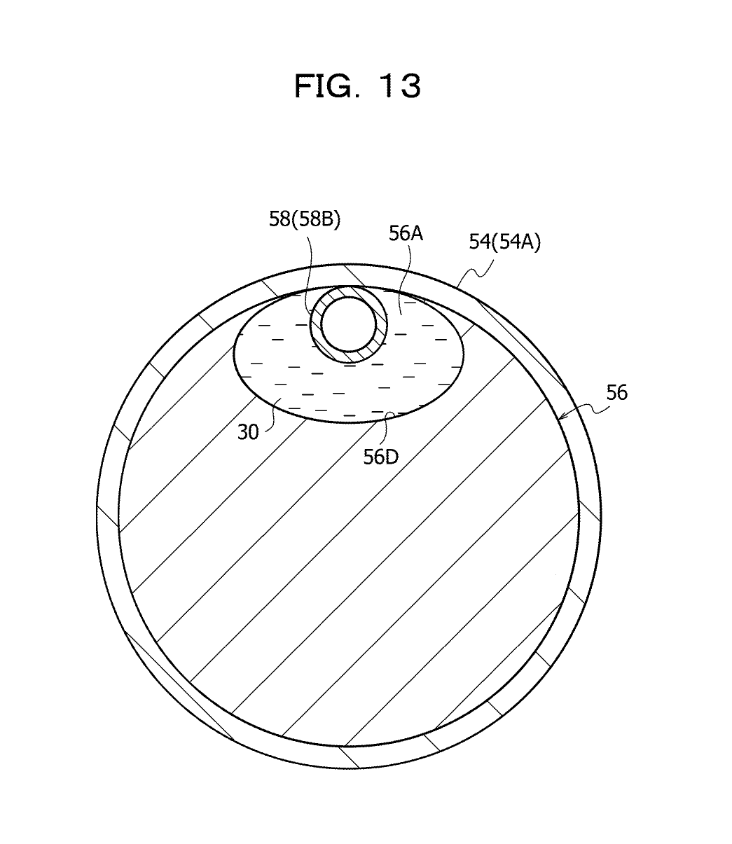

FIG. 13 is a cross-sectional view taken along line F13-F13 in FIG. 12. As illustrated in FIG. 13, a groove 56D extending in the axis direction of the throttle member 56 is formed at a position eccentric to the center of the throttle member 56 (for example, on the outer circumferential portion the throttle member 56), and the throttle hole 56A is formed by the inner circumferential surface of the groove 56D and a part of the inner circumferential surface of the main pipe 54. The throttle hole 56A is provided at a position eccentric to the center of the main pipe 54.

In this way, in the refrigerant liquid discharge apparatus D4 according to the fourth embodiment, the portion 58C from the end portion on the inlet side of the narrow tube 58 to the length direction central portion of the narrow tube 58 is fixed in a state where the portion 58C is in contact with the inner circumferential surface of the peripheral wall portion 52C of the manifold 52. Further, the portion 58D from the length direction central portion of the narrow tube 58 to the end portion on the outlet side of the narrow tube 58 is fixed in a state where the portion 58D is in contact with the inner circumferential surface of the inlet portion 54A of the main pipe 54. Thereby, it is possible to firmly fix the narrow tube 58 to the manifold 52 and the main pipe 54.

In the fourth embodiment, the groove 56D is formed a position eccentric to the center of the throttle member 56, and the throttle hole 56A is formed by the inner circumferential surface of the groove 56D and a part of the inner circumferential surface of the main pipe 54. However, the throttle hole 56A may be formed at a position eccentric to the center of the throttle member 56 (between the center and the circumferential surface of the throttle member 56). In this case, a portion from the outlet side end portion 58B of the narrow tube 58 to the length direction central portion of the narrow tube 58 may be fixed in a state where the portion is in contact with the inner circumferential surface of the inlet portion 54A of the main pipe 54. The outlet side end portion 58B of the narrow tube 58 may be inserted into the throttle hole 56A in a state where the outlet side end portion 58B is inwardly separated from the inner circumferential surface of the inlet portion 54A of the main pipe 54.

Although the refrigerant liquid discharge apparatus D4 according to the fourth embodiment is an apparatus obtained by changing the configuration of the refrigerant liquid discharge apparatus D1 according to the first embodiment described above, the refrigerant liquid discharge apparatus D4 may be an apparatus obtained by changing the configuration of the refrigerant liquid discharge apparatus D2 according to the second embodiment described above.

Further, the refrigerant liquid discharge apparatus D4 according to the fourth embodiment may be combined with the refrigerant liquid discharge apparatus D3 according to the third embodiment described above. Specifically, in the refrigerant liquid discharge apparatus D4 according to the fourth embodiment, the inlet 58A1 of the narrow tube 58 may face a direction crossing the length direction of the narrow tube 58, and the inlet side end portion 58A of the narrow tube 58 may be abutted against the top wall portion 52A of the manifold 52.

The modified examples of the first to the third embodiments described above may be appropriately applied to the fourth embodiment.

### Fifth Embodiment

Next, a fifth embodiment disclosed by the present application will be described.

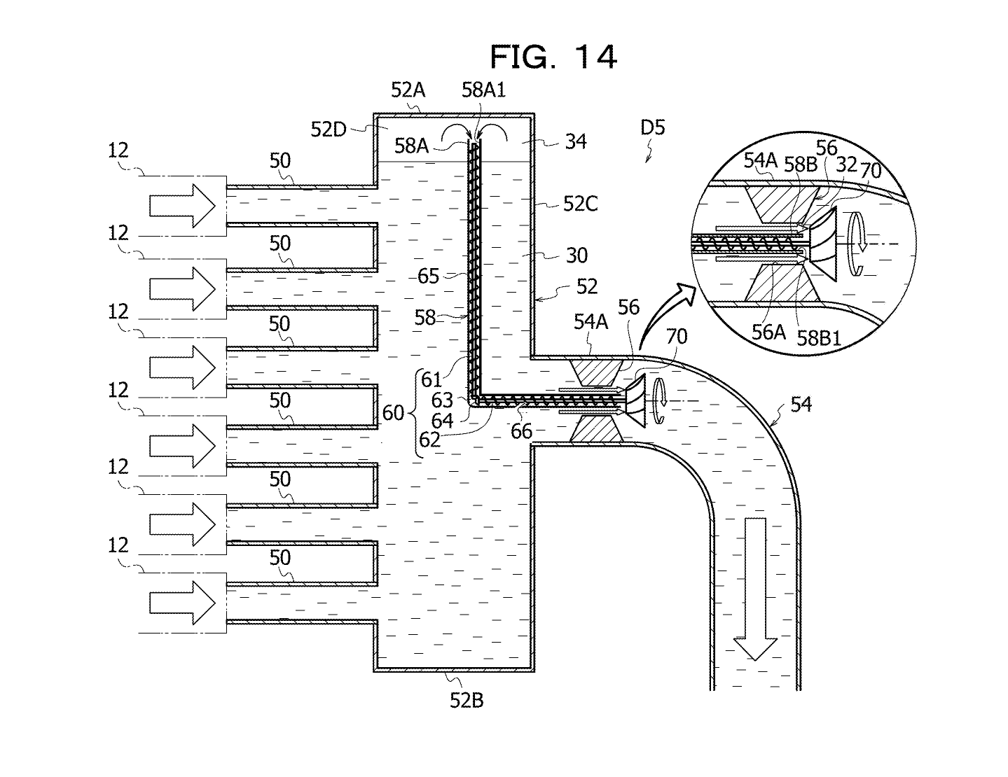

FIG. 14 is a side cross-sectional view illustrating a refrigerant liquid discharge apparatus D5 according to the fifth embodiment. In the same manner as the refrigerant liquid discharge apparatus D1 (see FIG. 1) according to the first embodiment and the refrigerant liquid discharge apparatus D2 (see FIG. 9) according to the second embodiment, the refrigerant liquid discharge apparatus D5 illustrated in FIG. 14 is applied on the discharge side of the cooling apparatus 20 provided in the information processing apparatus 10 (see FIGS. 3 to 8).

The refrigerant liquid discharge apparatus D5 according to the fifth embodiment has a configuration where the refrigerant liquid discharge apparatus D1 according to the first embodiment and the refrigerant liquid discharge apparatus D2 according to the second embodiment are combined. Specifically, the refrigerant liquid discharge apparatus D5 according to the fifth embodiment includes a plurality of pipes 50, a manifold 52, a main pipe 54, a throttle member 56, a narrow tube 58, a shaft 60, and an impeller 70.

The plurality of pipes 50, the manifold 52, the main pipe 54, the throttle member 56, and the narrow tube 58 are the same as those of the first embodiment described above. The shaft 60 and the impeller 70 are the same as those of the second embodiment described above. The outlet 58B1 of the narrow tube 58 is located on the downstream side of the throttle hole 56A. A position on the downstream side of the throttle hole 56A is a position where a desired suction force is obtained on the outlet side of the narrow tube 58 due to the high-speed flow 32.

When the refrigerant liquid discharge apparatus D5 is configured as described above, in the same manner as the first embodiment, when the refrigerant liquid 30 passes through the throttle member 56, the refrigerant liquid 30 is throttled by the throttle member 56, so that the high-speed flow 32 where the flow speed of the refrigerant liquid 30 is high is formed. Then, a pressure difference occurs between the inlet side and the outlet side of the narrow tube 58, so that a suction force is applied to the outlet side of the narrow tube 58. Therefore, the air 34 in the inside upper portion 52D of the manifold 52 may be sucked from the inlet 58A1 of the narrow tube 58 and may be discharged from the outlet 58B1 of the narrow tube 58.

When the impeller 70 is rotated by the flow of the refrigerant liquid 30, the first spiral portion 65 rotates along with the first shaft 61 and the second spiral portion 65 rotates along with the second shaft 62. The air 34 in the inside upper portion 52D of the manifold 52 may be taken into the narrow tube 58 from the inlet 58A1 of the narrow tube 58 and the air 34 may be involved in the first spiral portion 65 and the second spiral portion 66 and discharged from the outlet 58B1 of the narrow tube 58.

As described above, according to the refrigerant liquid discharge apparatus D5 according to the fifth embodiment, it is possible to discharge the air 34 present in the inside upper portion 52D of the manifold 52 from the outlet 58B1 of the narrow tube 58 by the pressure difference generated between the inlet side and the outlet side of the narrow tube 58 and the rotations of the first spiral portion 65 and the second spiral portion 66.

In particular, the high-speed flow 32 where the flow speed of the refrigerant liquid 30 is high is supplied to the impeller 70 by the throttle member 56, so that rotation speed of the impeller 70 increases. Therefore, for example, even when the main pipe 54 is thick and long or a flow rate of the refrigerant liquid 30 flowing through the main pipe 54 is low, it is possible to increase the amount of air conveyed by the first spiral portion 65 and the second spiral portion 66 by increasing of the rotation speed of the impeller 70. Thereby, it is possible to increase flow rate of air discharged from the outlet 58B1 of the narrow tube 58 as compared with the first embodiment and the second embodiment.

In the fifth embodiment, the outlet 58B1 of the narrow tube 58 is provided at a position where a desired suction force is obtained on the outlet side of the narrow tube 58 due to the high-speed flow 32. However, the outlet 58B1 of the narrow tube 58 may be separated from the throttle hole 56A to the downstream side to the extent that no suction force is generated on the outlet side of the narrow tube 58. In this case, discharge of air using the pressure difference generated between the inlet side and the outlet side of the narrow tube 58 is not performed. However, it is possible to efficiently discharge air from the outlet 58B1 of the narrow tube 58 by the rotations of the first spiral portion 65 and the second spiral portion 66 and the increasing of the rotation speed of the impeller 70 due to the high-speed flow 32.

The modified examples of the first to the fourth embodiments may be applied to the fifth embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a plurality of processors;
a manifold that collects refrigerant liquid discharged from the plurality of processors;
a first pipe that is coupled to the manifold and discharges the refrigerant liquid collected in the manifold;
a throttle portion that is disposed in the first pipe and forms a throttle hole penetrating in an axis direction of the first pipe inside the first pipe; and
a tube that extends from an inside upper portion of the manifold to inside of the first pipe and is inserted into the throttle hole.

2. The information processing apparatus according to claim 1,
wherein an outlet of the tube is located inside the throttle hole.

3. The information processing apparatus according to claim 1,
wherein the plurality of processors and the manifold are coupled by a plurality of second pipes,
the plurality of second pipes are arranged in a vertical direction, and
an outlet port from the manifold to the first pipe is located at a position lower than an inlet port from a pipe arranged at the uppermost of the plurality of second pipes in the vertical direction to the manifold.

4. The information processing apparatus according to claim 1,
wherein the plurality of processors and the manifold are coupled by a plurality of second pipes,
the plurality of second pipes are arranged in a vertical direction, and
an inlet of the tube is located at a position higher than an inlet port from a pipe arranged at the uppermost of the plurality of second pipes in the vertical direction to the manifold.

5. The information processing apparatus according to claim 1,
wherein an inlet of the tube faces a direction crossing a length direction of the tube, and
an inlet side end portion of the tube is abutted against a top wall portion of the manifold.

6. The information processing apparatus according to claim 1,
wherein the throttle hole is disposed on a center of the first pipe.

7. The information processing apparatus according to claim 1,
wherein the first pipe is disposed with a throttle portion that forms a throttle hole penetrating in an axis direction of the first pipe inside the first pipe,
a portion from an end portion on an inlet side of the tube to a length direction central portion of the tube is fixed in a state where the portion is in contact with an inner circumferential surface of a peripheral wall portion of the manifold, and
a portion from the length direction central portion of the tube to an end portion on an outlet side of the tube is fixed in a state where the portion is in contact with an inner circumferential surface of the first pipe.

8. The information processing apparatus according to claim 7,
wherein the throttle hole is disposed at a position eccentric to a center of the first pipe.

9. An information processing apparatus comprising:
a plurality of processors;
a manifold that collects refrigerant liquid discharged from the plurality of processors;
a first pipe that is coupled to the manifold and discharges the refrigerant liquid collected in the manifold;
a tube that extends from an inside upper portion of the manifold to inside of the first pipe;
a shaft having spiral portions, each of which is disposed inside the tube, extends in a length direction of the tube, and has a spiral shape around a shaft direction on an outer circumferential portion; and
an impeller coupled to an end portion protruded from an outlet of the tube in the shaft.

10. The information processing apparatus according to claim 9,
wherein the spiral portions have a spiral shape in a direction in which air present in an inside upper portion of the manifold is delivered from the inside upper portion of the manifold to the outlet of the tube accompanying rotation of the impeller.

11. An information processing apparatus comprising:
a plurality of processors;
a manifold that collects refrigerant liquid discharged from the plurality of processors;
a first pipe that is coupled to the manifold and discharges the refrigerant liquid collected in the manifold;
a throttle portion that is disposed in the first pipe and forms a throttle hole penetrating in an axis direction of the first pipe inside the first pipe;
a tube that extends from an inside upper portion of the manifold to inside of the first pipe and is inserted into the throttle hole;
a shaft having spiral portions, each of which is disposed inside the tube, extends in a length direction of the tube, and has a spiral shape around a shaft direction on an outer circumferential portion; and
an impeller coupled to an end portion protruded from an outlet of the tube in the shaft.
